(19) United States
(12) Patent Application Publication
(10) Pub. No.: US 2026/0312319 A1
(43) Pub. Date: Oct. 8, 2026

(54) CONNECTOR

(71) Applicant: BIZLINK INTERNATIONAL CORP., New Taipei City (TW)

(72) Inventors: Kaiwen ZHENG, New Taipei City (TW); Chin-An HSIEH, New Taipei City (TW)

(21) Appl. No.: 19/575,932

(22) Filed: Mar. 24, 2026

(30) Foreign Application Priority Data
Apr. 8, 2025 (TW) 114113269

(51) Int. Cl. H01R 13/11; H01R 4/48; H01R 13/24; H01R 12/71

(52) U.S. Cl. CPC H01R 13/113; H01R 4/48; H01R 13/2435; H01R 12/716

(57) ABSTRACT

A connector includes a housing, a ground terminal, and a common ground connecting part. The housing has an accommodating space. The ground terminal is accommodated in the accommodating space of the housing. The ground terminal further includes a fixed portion fixed in the housing and a free portion connected to the fixed portion. The free portion has a hole. The common ground connecting part is disposed on the free portion of the ground terminal. The common ground connecting part includes a ground main body and a ground fin vertically extending from the ground main body. The ground fin passes through the hole of the free portion. The common ground connecting part is electrically connected to the ground terminal.

This application claims priority to Taiwan Application Serial Number 114113269, filed Apr. 8, 2025, which is herein incorporated by reference in its entirety.

### BACKGROUND

### Field of Invention

The present disclosure relates to a connector.

### Description of Related Art

When connectors located at two ends are coupled with each other to transmit signals, how to filter noise in the signals is a crucial issue. As future generations of networks continue to advance, server-related equipment (for example, connectors) must also be adjusted to accommodate high-speed networks. In other words, the structure of existing connectors is no longer capable of meeting the requirement for filtering noise in a high-speed network environment.

Therefore, how to propose a connector that can solve the aforementioned problems is one of the problems that the industry is currently eager to invest in research and development resources to solve.

### SUMMARY

In view of this, one purpose of the present disclosure is to provide a connector that can solve the aforementioned problems.

In order to achieve the above objective, according to an embodiment of the present disclosure, a connector includes a housing, a ground terminal, and a common ground connecting part. The housing has an accommodating space. The ground terminal is accommodated in the accommodating space of the housing. The ground terminal further includes a fixed portion fixed in the housing and a free portion connected to the fixed portion. The free portion has a hole. The common ground connecting part is disposed on the free portion of the ground terminal. The common ground connecting part includes a ground main body and a ground fin vertically extending from the ground main body. The ground fin passes through the hole of the free portion. The common ground connecting part is electrically connected to the ground terminal.

In summary, in the connector of the present disclosure, since the common ground connecting part of the connector is disposed on the free portion of the ground terminal, when another connector is coupled with the connector of the present disclosure, noise can be filtered at an early stage at a front end of the ground terminal (i.e., the free portion), thereby ensuring the quality of high-speed signals.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a connector in accordance with an embodiment of the present disclosure;

FIG. 2 is a cross-sectional view of the connector based on a section 2-2 of FIG. 1 in accordance with an embodiment of the present disclosure;

FIG. 3 is a perspective view of a ground terminal, a first signal terminal, a second signal terminal, an insulating part, and a common ground connecting part in accordance with an embodiment of the present disclosure;

FIG. 4 is a perspective view of the common ground connecting part in accordance with an embodiment of the present disclosure;

FIG. 5 is a top view of the ground terminal, the first signal terminal, the second signal terminal, the insulating part, and the common ground connecting part in accordance with an embodiment of the present disclosure;

FIG. 6 is a cross-sectional view of the ground terminal, the insulating part, and the common ground connecting part based on a section 6-6 of FIG. 5 in accordance with an embodiment of the present disclosure; and

FIG. 7 is a cross-sectional view of the ground terminal, the first signal terminal, the second signal terminal, the insulating part, and the common ground connecting part based on a section 7-7 of FIG. 5 in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit the present disclosure. In other words, in some embodiments of the present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a connector 100 of this embodiment and the connection relationship between the components will be described in detail.

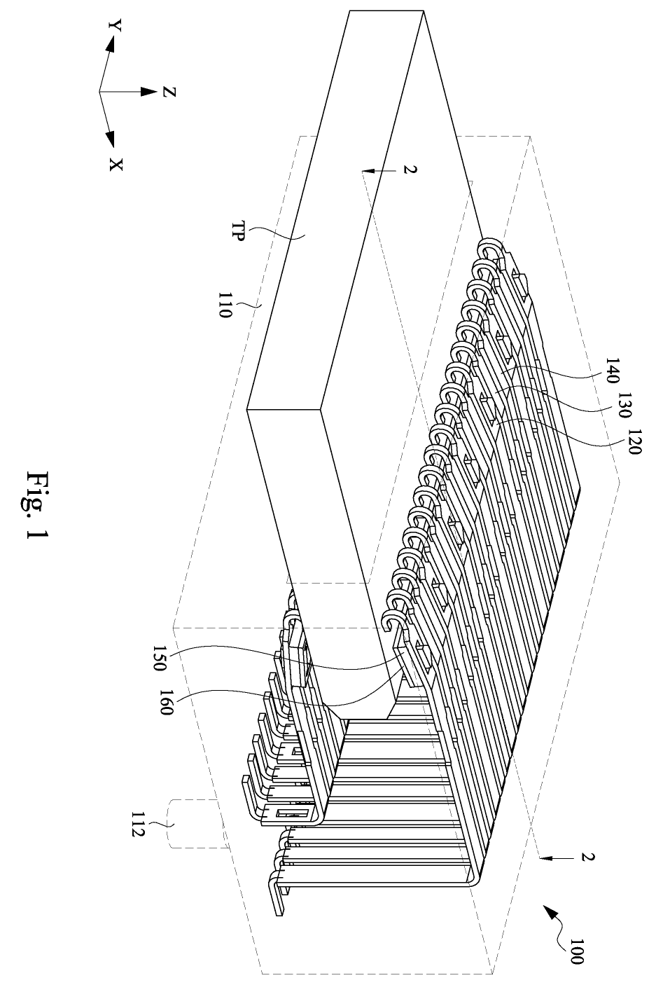

Reference is made to FIG. 1. FIG. 1 is a perspective view of the connector 100 in accordance with an embodiment of the present disclosure. As shown in FIG. 1, in this embodiment, the connector 100 is configured to be coupled with a tongue portion TP of another connector. The connector 100 includes a housing 110, a ground terminal 120, a first signal terminal 130, a second signal terminal 140, an insulating part 150, and a common ground connecting part 160. The housing 110 accommodates the ground terminal 120, the first signal terminal 130, the second signal terminal 140, the insulating part 150, and the common ground connecting part 160. The housing 110 is configured to be coupled with the tongue portion TP of another connector, such that when the tongue portion TP is coupled with the connector 100, the ground terminal 120, the first signal terminal 130, and the second signal terminal 140 can contact the tongue portion TP to enable signal transmission.

The housing 110 further includes a positioning post 112. The housing 110 is fixed on a circuit board (not shown) by the positioning post 112.

The ground terminal 120, the first signal terminal 130, and the second signal terminal 140 are separated from each other. Specifically, the first signal terminal 130 is separated from the ground terminal 120, and the second signal terminal 140 is separated from the ground terminal 120 and the first signal terminal 130. As shown in FIG. 1, in some embodiments, the connector 100 includes a plurality of ground terminals 120, a plurality of first signal terminals 130, and a plurality of second signal terminals 140. The ground terminals 120, the first signal terminals 130, and the second signal terminals 140 are alternately arranged along a direction (e.g., direction Y). Specifically, the ground terminals 120, the first signal terminals 130, and the second signal terminals 140 are cyclically arranged along a direction (e.g., direction Y) in this order.

The insulating part 150 and the common ground connecting part 160 are disposed on the ground terminal 120. The insulating part 150 is located between the ground terminal 120 and the common ground connecting part 160.

In some embodiments, the connector 100 includes an upper row terminal set and a lower row terminal set located in the housing 110, in which each of the upper row terminal set and the lower row terminal set includes the ground terminal 120, the first signal terminal 130, and the second signal terminal 140, such that the upper row terminal set and the lower row terminal set jointly clamp the tongue portion TP. The connector 100 further includes a first common ground connecting part 160 disposed on the ground terminals 120 of the upper row terminal set and a second common ground connecting part 160 disposed on the ground terminals 120 of the lower row terminal set. The first common ground connecting part 160 and the second common ground connecting part 160 are located between the upper row terminal set and the lower row terminal set and face toward to each other.

In some embodiments, the connector 100 may be, for example, a board side connector. In some other embodiments, the connector 100 may also be, for example, a wire side connector. However, the present disclosure is not intended to limit the type of the connector 100.

In some embodiments, the housing 110 may include plastic or other suitable insulating materials. The present disclosure is not intended to limit the material of the housing 110.

In some embodiments, the ground terminal 120, the first signal terminal 130, the second signal terminal 140, and the common ground connecting part 160 may include metal or other suitable conductive materials. The present disclosure is not intended to limit the materials of the ground terminal 120, the first signal terminal 130, the second signal terminal 140, and the common ground connecting part 160.

In some embodiments, the insulating part 150 may include rubber, plastic, or other suitable insulating materials. The present disclosure is not intended to limit the material of the insulating part 150.

In some embodiments, the first signal terminal 130 and the second signal terminal 140 respectively serve as a high-speed terminal configured to transmit high-speed signals and a low-speed terminal configured to transmit low-speed signals. In some other embodiments, the ground terminal 120, the second signal terminal 140, and the first signal terminal 130 are alternately arranged along a direction (e.g., direction Y).

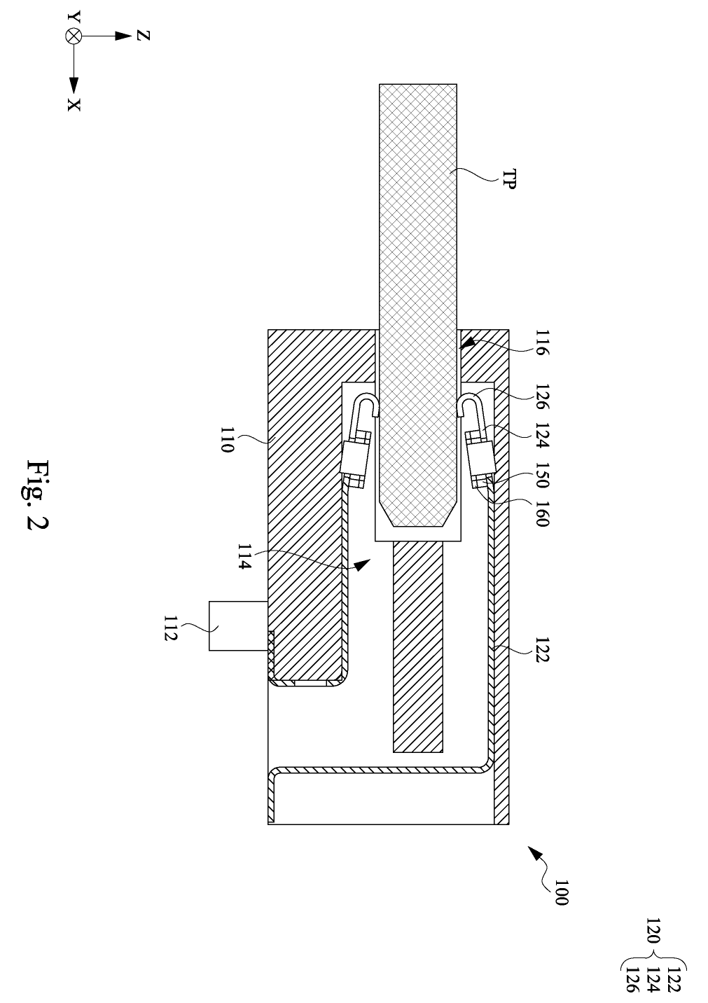

Reference is made to FIG. 2. FIG. 2 is a cross-sectional view of the connector 100 based on a section 2-2 of FIG. 1 in accordance with an embodiment of the present disclosure. As shown in FIG. 2, in this embodiment, the housing 110 further includes an accommodating space 114 and an insertion opening 116. The accommodating space 114 accommodates the ground terminal 120, the first signal terminal 130, the second signal terminal 140, the insulating part 150, and the common ground connecting part 160. The insertion opening 116 communicates with the accommodating space 114. The accommodating space 114 is located on a side of the housing 110 away from the tongue portion TP, and the insertion opening 116 is located on a side of the housing 110 close to the tongue portion TP. In a usage scenario, when a user intends to insert the tongue portion TP into the connector 100, the tongue portion TP first passes through the insertion opening 116 and then enters the accommodating space 114. The ground terminal 120 includes a fixed portion 122, a free portion 124, and a bending portion 126. The free portion 124 is connected between the fixed portion 122 and the bending portion 126. Specifically, the fixed portion 122 is fixed in the housing 110. The free portion 124 is connected to the fixed portion 122 and is not fixed in the housing 110. In some embodiments, a gap is between the free portion 124 and an inner surface of the housing 110. The bending portion 126 is connected to the free portion 124, and the bending portion 126 and the free portion 124 are movable relative to the fixed portion 122 and are not fixed in the housing 110. As shown in FIG. 2, the insulating part 150 and the common ground connecting part 160 are disposed on the free portion 124 of the ground terminal 120, and a portion of the common ground connecting part 160 passes through the insulating part 150 and the free portion 124 of the ground terminal 120.

In some embodiments, the bending portion 126 has, for example, a cane-shaped form or a capital U-shaped form. This enables a side of the bending portion 126 away from the free portion 124 to easily contact the tongue portion TP.

As shown in FIG. 2, in some embodiments, a portion of the fixed portion 122 fixed in the housing 110 is elongated along a direction (e.g., direction X). In some embodiments, a direction in which the free portion 124 is elongated forms an acute angle with the inner surface of the housing 110.

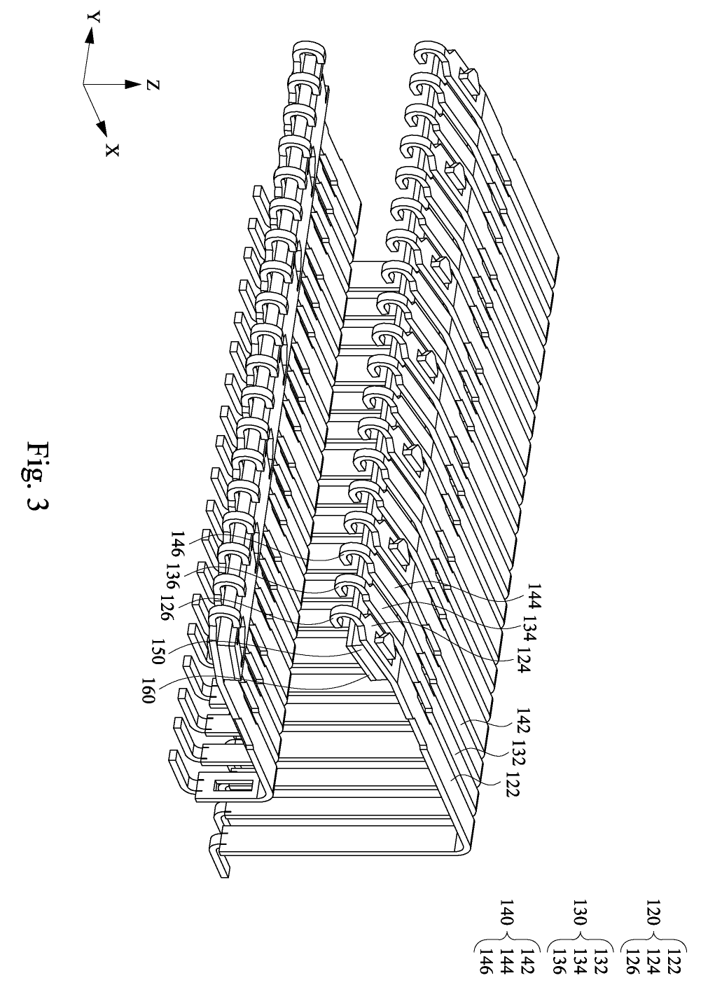

Reference is made to FIG. 3. FIG. 3 is a perspective view of the ground terminal 120, the first signal terminal 130, the second signal terminal 140, the insulating part 150, and the common ground connecting part 160 in accordance with an embodiment of the present disclosure. For simplicity, the housing 110 is omitted in FIG. 3. As shown in FIG. 3, in this embodiment, the first signal terminal 130 includes a fixed portion 132, a free portion 134, and a bending portion 136, and the second signal terminal 140 also includes a fixed portion 142, a free portion 144, and a bending portion 146. The fixed portion 122, the fixed portion 132, and the fixed portion 142 are arranged in parallel along a direction (e.g., direction Y). The free portion 124, the free portion 134, and the free portion 144 are arranged in parallel along a direction (e.g., direction Y). The bending portion 126, the bending portion 136, and the bending portion 146 are arranged in parallel along a direction (e.g., direction Y). The insulating part 150 extends across (transverse to) the ground terminal 120, the first signal terminal 130, and the second signal terminal 140 along a direction (e.g., direction Y). The first common ground connecting part 160 and second common ground connecting part 160 respectively extend across (transverse to) the ground terminal 120, the first signal terminal 130, and the second signal terminal 140 of the upper row terminal set and the lower row terminal set along a direction (e.g., direction Y). As shown in FIG. 3, the insulating part 150 is located not only between the ground terminal 120 and the common ground connecting part 160 but also between the first signal terminal 130 and the common ground connecting part 160, and further between the second signal terminal 140 and the common ground connecting part 160.

In some embodiments, the free portion 124 of the ground terminal 120, the insulating part 150, and the common ground connecting part 160 are sequentially arranged along a direction (e.g., direction Z). In some embodiments, the free portion 134 of the first signal terminal 130, the insulating part 150, and the common ground connecting part 160 are sequentially arranged along a direction (e.g., direction Z). In some embodiments, the free portion 144 of the second signal terminal 140, the insulating part 150, and the common ground connecting part 160 are sequentially arranged along a direction (e.g., direction Z).

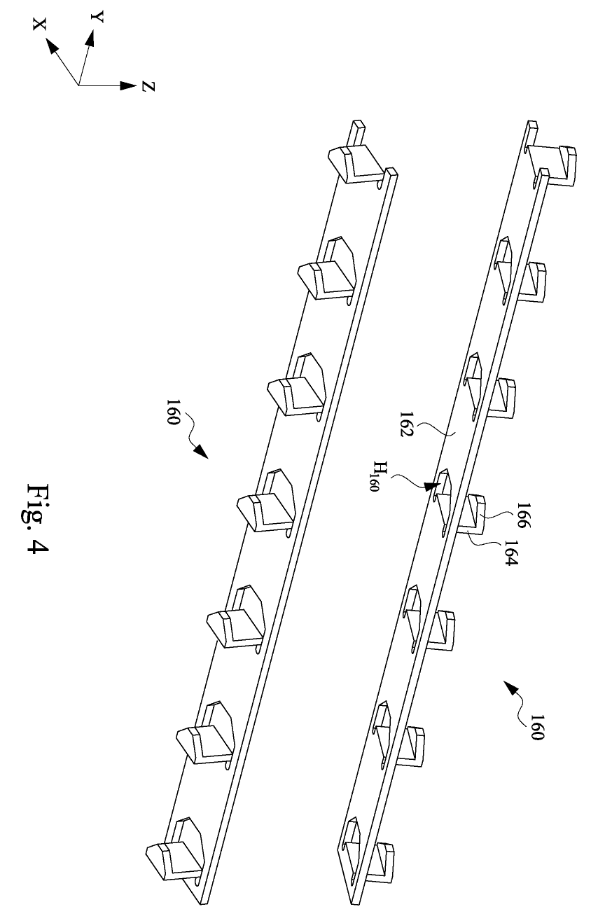

Reference is made to FIG. 4. FIG. 4 is a perspective view of the common ground connecting part 160 in accordance with an embodiment of the present disclosure. As shown in FIG. 4, in this embodiment, the common ground connecting part 160 includes a ground main body 162, a ground fin 164, and a contacting portion 166. The ground main body 162 is elongated along a direction (e.g., direction Y). In some embodiments, the ground main body 162 is substantially plate-shaped. The ground fin 164 extends from the ground main body 162. Specifically, the ground fin 164 vertically extends from the ground main body 162. In some embodiments, the ground fin 164 extends along a direction (e.g., direction Z).

The contacting portion 166 is bent from the ground fin 164. Specifically, the contacting portion 166 vertically extends from the ground fin 164. In some embodiments, the contacting portion 166 extends in parallel with the ground main body 162 along a direction (e.g., direction Y). The common ground connecting part 160 further has a perforation H₁₆₀. The perforation H₁₆₀ is located on the ground main body 162, and the perforation H₁₆₀ is adjacent to a connection between the ground fin 164 and the ground main body 162. Specifically, the common ground connecting part 160 is formed by a punching process such that the ground fin 164 extends from the ground main body 162, thereby forming the perforation H₁₆₀. Thereafter, the ground fin 164 is subjected to a stamping process such that an upper portion of the ground fin 164 is bent, thereby forming the contacting portion 166.

As shown in FIG. 4, each of common ground connecting parts 160 may include one ground main body 162, a plurality of ground fins 164, and a plurality of contacting portions 166. The contacting portions 166 are respectively bent from the ground fins 164.

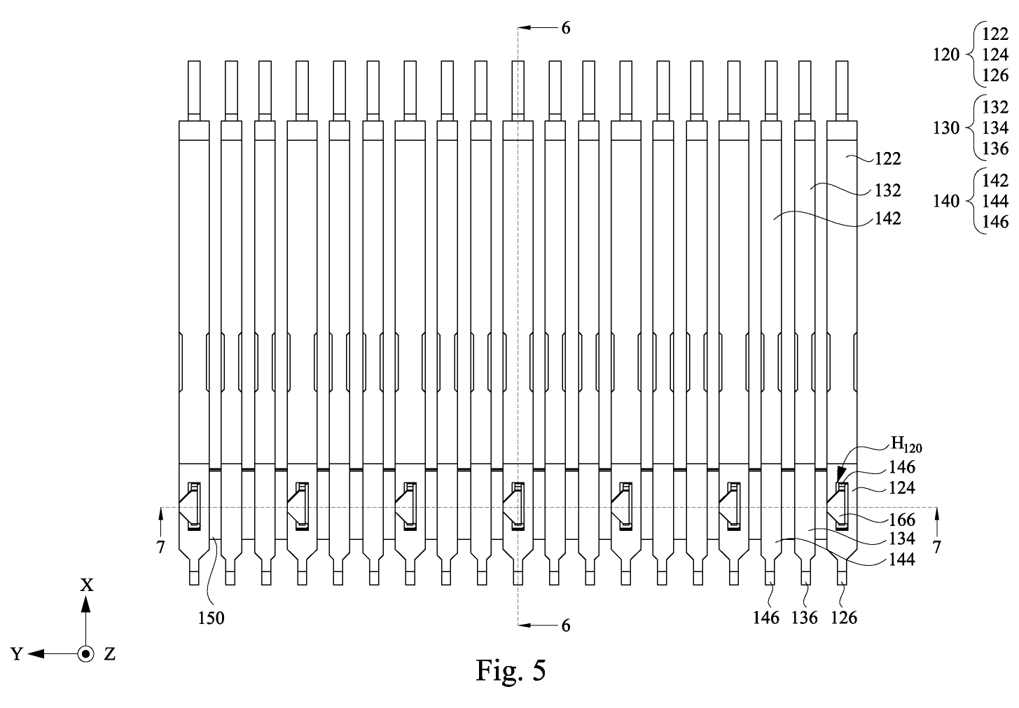

Reference is made to FIG. 5. FIG. 5 is a top view of the ground terminal 120, the first signal terminal 130, the second signal terminal 140, the insulating part 150, and the common ground connecting part 160 in accordance with an embodiment of the present disclosure. As shown in FIG. 5, in this embodiment, the ground terminal 120 further has a hole H₁₂₀. Specifically, the free portion 124 of the ground terminal 120 has the hole H₁₂₀ (i.e., the hole H₁₂₀ is located on the free portion 124 of the ground terminal 120). The hole H₁₂₀ is configured to allow the ground fin 164 of the common ground connecting part 160 to pass through. The contacting portion 166 contacts the ground terminal 120 such that the common ground connecting part 160 is electrically connected to the ground terminal 120. The detailed operating principle of the common ground connecting part 160 will be further described below.

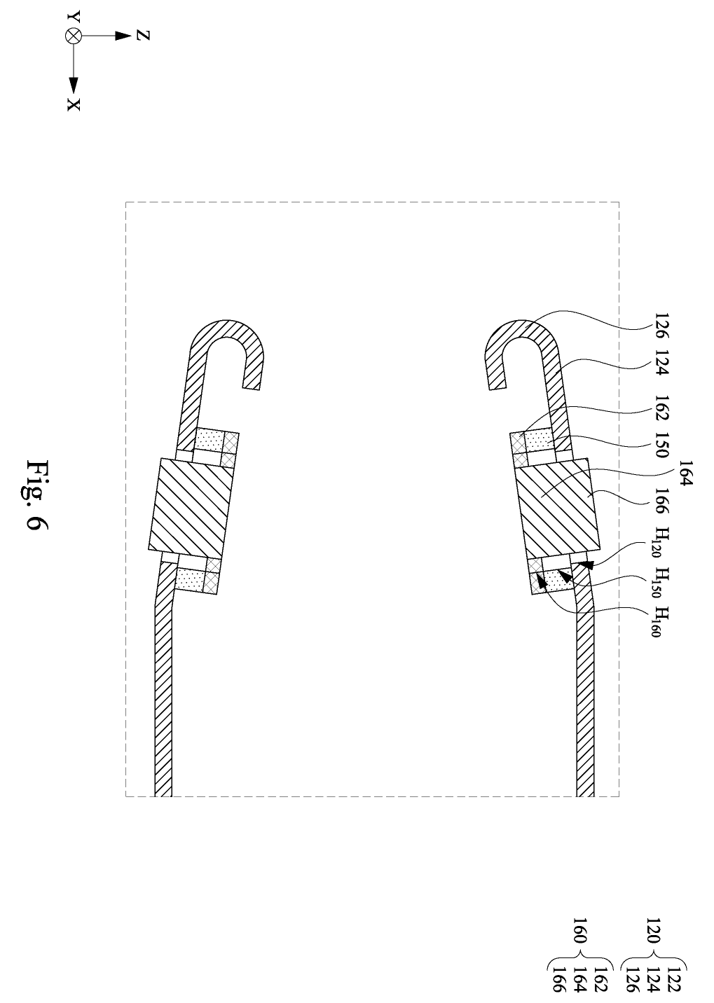

Reference is made to FIG. 6. FIG. 6 is a cross-sectional view of the ground terminal 120, the insulating part 150, and the common ground connecting part 160 based on a section 6-6 of FIG. 5 in accordance with an embodiment of the present disclosure. As shown in FIG. 6, in this embodiment, the insulating part 150 further has a hole H₁₅₀. The hole H₁₅₀of the insulating part 150 is configured to allow the ground fin 164 of the common ground connecting part 160 to pass through. Specifically, the ground fin 164 vertically extends from the ground main body 162 and simultaneously passes through the hole H₁₅₀ of the insulating part 150 and the hole H₁₂₀ of the free portion 124 of the ground terminal 120. The contacting portion 166 extends toward a direction (e.g., a positive direction Y) and is located over the free portion 124 of the ground terminal 120. In some embodiments in which the free portion 124 of the ground terminal 120 is not elongated in parallel with direction X, the ground fin 164 of the common ground connecting part 160 does not extend in parallel with direction Z. However, the present disclosure is not intended to limit the extending direction of the ground fin 164.

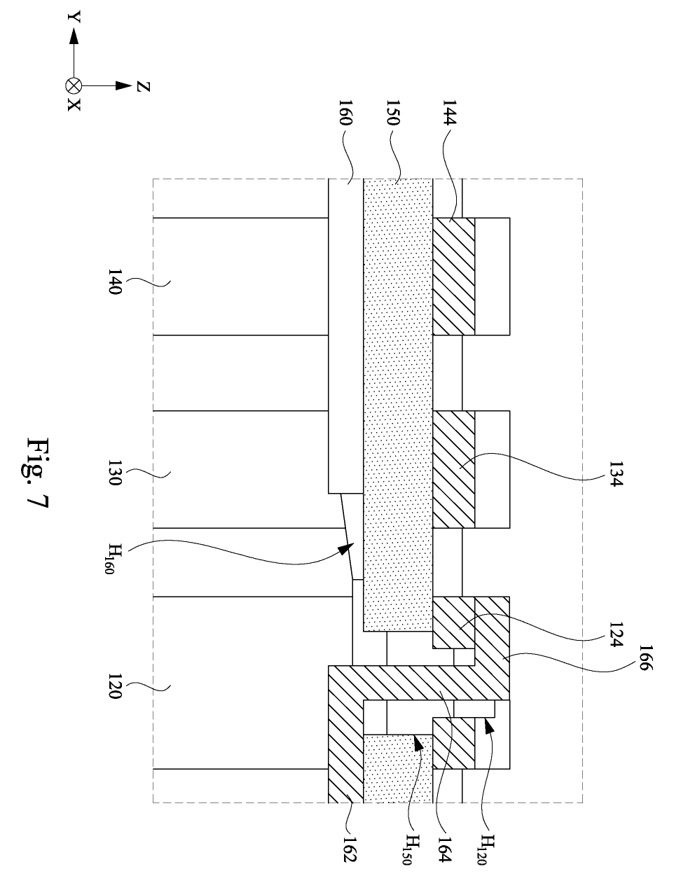

Reference is made to FIG. 7. FIG. 7 is a cross-sectional view of the ground terminal 120, the first signal terminal 130, the second signal terminal 140, the insulating part 150, and the common ground connecting part 160 based on a section 7-7 of FIG. 5 in accordance with an embodiment of the present disclosure. As shown in FIG. 7, in this embodiment, the ground main body 162 of the common ground connecting part 160 extends across the free portion 124 of the ground terminal 120, the free portion 134 of the first signal terminal 130, and the free portion 144 of the second signal terminal 140. The ground fin 164 of the common ground connecting part 160 passes only through the hole H₁₅₀of the insulating part 150 and the hole H₁₂₀ of the free portion 124 of the ground terminal 120, and does not pass through the first signal terminal 130 or the second signal terminal 140. In other words, the free portion 134 of the first signal terminal 130 and the free portion 144 of the second signal terminal 140 do not have hollowed portions configured to allow the ground fin 164 to pass through.

As shown in FIGS. 6 and FIG. 7, the hole H₁₅₀ of the insulating part 150 communicates with the hole H₁₂₀ of the free portion 124 of the ground terminal 120. The hole H₁₅₀ of the insulating part 150 is located only under the hole H₁₂₀ of the free portion 124 of the ground terminal 120 and is not located under the free portion 134 of the first signal terminal 130 or the free portion 144 of the second signal terminal 140. In other words, the insulating part 150 does not have hollowed portions under the free portion 134 of the first signal terminal 130 or under the free portion 144 of the second signal terminal 140 configured to allow the ground fin 164 to pass through. In some embodiments, the hole H₁₅₀of the insulating part 150 and the hole H₁₂₀ of the free portion 124 of the ground terminal 120 are aligned along a direction (e.g., direction Z).

As shown in FIGS. 5 and FIG. 7, the contacting portion 166 of the common ground connecting part 160 vertically extends from the ground fin 164 and covers a portion of the free portion 124 of the ground terminal 120. This ensures that the contacting portion 166 can reliably contact the ground terminal 120, such that the common ground connecting part 160 is electrically connected to the plurality of ground terminals 120.

From the above detailed description of the specific embodiments of the present disclosure, it can be clearly seen that, in the connector of the present disclosure, since the common ground connecting part of the connector is disposed on the free portion of the ground terminal, when another connector is coupled with the connector of the present disclosure, noise can be filtered at an early stage at a front end of the ground terminal (i.e., the free portion), thereby ensuring the quality of high-speed signals.

Although the present disclosure has been described with reference to the above embodiments, it is not intended to limit the present disclosure. Various modifications and refinements may be made by those skilled in the art without departing from the spirit and scope of the present disclosure. Therefore, the scope of protection of the present disclosure shall be defined by the appended claims.

What is claimed is:

1. A connector, comprising:
a housing having an accommodating space;
a ground terminal accommodated in the accommodating space of the housing, and the ground terminal further comprising a fixed portion fixed in the housing and a free portion connected to the fixed portion, wherein the free portion has a hole; and
a common ground connecting part disposed on the free portion of the ground terminal, and the common ground connecting part comprising a ground main body and a ground fin vertically extending from the ground main body, wherein the ground fin passes through the hole of the free portion, and the common ground connecting part is electrically connected to the ground terminal.

2. The connector of claim 1, further comprising:
an insulating part disposed between the common ground connecting part and the ground terminal.

3. The connector of claim 1, further comprising:
a first signal terminal separated from the ground terminal; and
a second signal terminal separated from the first signal terminal and the ground terminal,
wherein the ground terminal, the first signal terminal, and the second signal terminal are arranged sequentially.

4. The connector of claim 3, further comprising:
an insulating part disposed between the common ground connecting part and the ground terminal, wherein the insulating part is located between the common ground connecting part and the first signal terminal, and wherein the insulating part is located between the common ground connecting part and the second signal terminal.

5. The connector of claim 1, wherein the common ground connecting part further comprises a contacting portion bent from the ground fin, and the contacting portion contacts the ground terminal.

6. The connector of claim 1, further comprising:
a plurality of first signal terminals separated from a plurality of the ground terminals; and
a plurality of second signal terminals separated from the first signal terminals and the ground terminals, wherein the ground terminals, the first signal terminals, and the second signal terminals are alternately arranged along a direction.

7. The connector of claim 6, wherein the common ground connecting part extends across the ground terminals, the first signal terminals, and the second signal terminals along the direction.

8. The connector of claim 7, further comprising:
an insulating part extending across the ground terminals, the first signal terminals, and the second signal terminals and disposed between one of the ground terminals and the common ground connecting part, wherein the insulating part is located between one of the first signal terminals and the common ground connecting part, and wherein the insulating part is located between one of the second signal terminals and the common ground connecting part.

9. The connector of claim 7, wherein the common ground connecting part further comprises a plurality of contacting portions respectively bent from a plurality of the ground fins, and the contacting portions contact the ground terminals.

10. The connector of claim 1, wherein the common ground connecting part has a perforation located on the ground main body, and the perforation is adjacent to a connection between the ground fin and the ground main body.

11. A connector, comprising:
a housing having an accommodating space;
an upper row terminal set and a lower row terminal set located in the housing, wherein the upper row terminal set or the lower row terminal set comprises:
a plurality of ground terminals accommodated in the accommodating space of the housing, and one of the ground terminals further comprising a fixed portion fixed in the housing and a free portion connected to the fixed portion, wherein the free portion has a hole;
a plurality of first signal terminals separated from the ground terminals; and
a plurality of second signal terminals separated from the first signal terminals and the ground terminals;
a first common ground connecting part disposed on the free portion of the ground terminals of the upper row terminal set; and
a second common ground connecting part disposed on the free portion of the ground terminals of the lower row terminal set, and the first common ground connecting part or the second common ground connecting part comprising a ground main body and a ground fin vertically extending from the ground main body, wherein the ground fin passes through the hole of the free portion, the first common ground connecting part is electrically connected to the ground terminals of the upper row terminal set, and the second common ground connecting part is electrically connected to the ground terminals of the lower row terminal set, wherein the first common ground connecting part extends across the ground terminals, the first signal terminals, and the second signal terminals of the upper row terminal set along a direction, and the second common ground connecting part extends across the ground terminals, the first signal terminals, and the second signal terminals of the lower row terminal set along the direction.

12. The connector of claim 11, further comprising:
an insulating part disposed between the first common ground connecting part and the ground terminals of the upper row terminal set or between the second common ground connecting part and the ground terminals of the lower row terminal set.

13. The connector of claim 12, wherein the insulating part is located between the first common ground connecting part and the first signal terminals of the upper row terminal set or between the second common ground connecting part and the first signal terminals of the lower row terminal set, and wherein the insulating part is located between the first common ground connecting part and the second signal terminals of the upper row terminal set or between the second common ground connecting part and the second signal terminals of the lower row terminal set.

14. The connector of claim 12, wherein the insulating part extends across the ground terminals, the first signal terminals, and the second signal terminals.

15. The connector of claim 11, wherein the ground terminals, the first signal terminals, and the second signal terminals are arranged sequentially.

16. The connector of claim 11, wherein the first common ground connecting part or the second common ground connecting part further comprises a contacting portion bent from the ground fin, and the contacting portion contacts the ground terminals.

17. The connector of claim 11, wherein the ground terminals, the first signal terminals, and the second signal terminals are alternately arranged along the direction.

18. The connector of claim 11, wherein the first common ground connecting part and the second common ground connecting part are located between the upper row terminal set and the lower row terminal set and face toward to each other.

19. The connector of claim 11, wherein the first common ground connecting part or the second common ground connecting part further comprises a plurality of contacting portions respectively bent from a plurality of the ground fins, and the contacting portions contact the ground terminals.

20. The connector of claim 11, wherein the first common ground connecting part or the second common ground connecting part has a perforation located on the ground main body, and the perforation is adjacent to a connection between the ground fin and the ground main body.
